(19) United States
(12) Patent Application Publication
(10) Pub. No.: US 2024/0336220 A1
(43) Pub. Date: Oct. 10, 2024

(54) BUCKLE FOR SEAT BELT

(71) Applicant: Rinat BABAYOF, Rishon le Zion (IL)

(72) Inventor: Rinat BABAYOF, Rishon le Zion (IL)

(21) Appl. No.: 18/622,959

(22) Filed: Mar. 31, 2024

Related U.S. Application Data
(60) Provisional application No. 63/494,005, filed on Apr. 4, 2023.

(51) Int. Cl. B60R 22/32; B60R 22/26; B60R 22/48

(52) U.S. Cl. CPC B60R 22/321; B60R 22/26; B60R 22/48; B60R 2022/4866

(57) ABSTRACT

A buckle for a seat belt, the buckle including an electro-mechanical mechanism being user operable to allow mechanical opening of the buckle.

### CROSS-REFERENCE TO RELATED APPLICATIONS

This application claims the benefit of priority from U.S. Provisional Application No. 63/494,005, filed Apr. 4, 2023, the disclosure of which is incorporated herein by reference.

### TECHNICAL FIELD

The invention relates to the field of seat belts.

### BACKGROUND

FIG. 1 depicts a prior art seat belt unlocked.

A prior art seat belt 20 includes a buckle 52, being secured to the seat 50A, a strap 16A, and a tongue 14A.

FIG. 2 depicts the prior art seat belt of FIG. 1 being locked.

Tongue 14A is for being lockable to buckle 52.

Buckle 52 includes a button 12A, for sliding (22) it in relation to a package 12B, for releasing the locking by pressing on button 12A.

However, the passenger alone may unlock buckle 52. The passenger may open the belt at any given time, even while driving, taking risks of not being protected by seat belts while traveling in the car

There is a long felt need to provide a solution to the above-mentioned and other problems of the prior art.

### SUMMARY

A buckle for a seat belt, the buckle including an electro-mechanical mechanism being user operable to allow mechanical opening of the buckle.

### BRIEF DESCRIPTION OF THE DRAWINGS

Embodiments, features, and aspects of the invention are described herein in conjunction with the following drawings, in which:

FIG. 1 depicts a prior art seat belt unlocked;

FIG. 2 depicts the prior art seat belt of FIG. 1 being locked;

FIG. 3 depicts a seat belt according to one embodiment of the invention, being unlocked;

FIG. 4 depicts the seat belt of FIG. 3 being locked;

FIG. 5 depicts the seat belt of FIG. 3 being locked and removed of the package, at the state being immediately after the locking of the tongue to the buckle;

FIG. 6 enlarges the mechanism at the state of FIG. 5;

FIG. 7 depicts the latch and the button of FIG. 5;

FIG. 8 depicts a user interface, for controlling the mechanism of FIG. 7, at the state of FIG. 7;

FIG. 9 depicts the user interface of FIG. 8 controlling the mechanism of FIG. 7 to a different state;

FIG. 10 depicts the seat belt of FIG. 3 being locked and removed of the package, once the user operates the user interface to avoid sliding the button;

FIG. 11 enlarges the mechanism at the state of FIG. 10;

FIG. 12 depicts the latch and the button of FIG. 11;

FIG. 13 depicts the mechanism of FIG. 6 according to another embodiment;

FIG. 14 depicts a seat belt shown unlocked according to another embodiment of the invention; and

FIG. 15 depicts a vehicle including the buckles of FIG. 14.

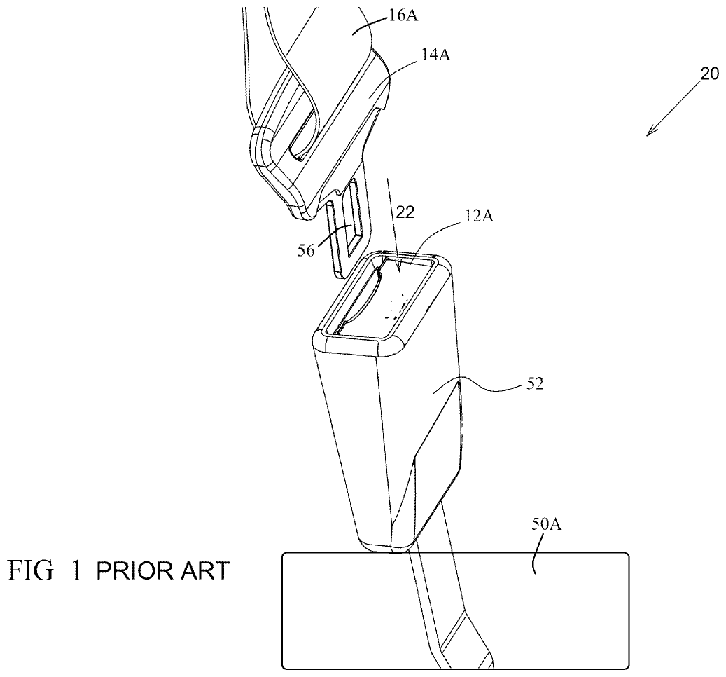

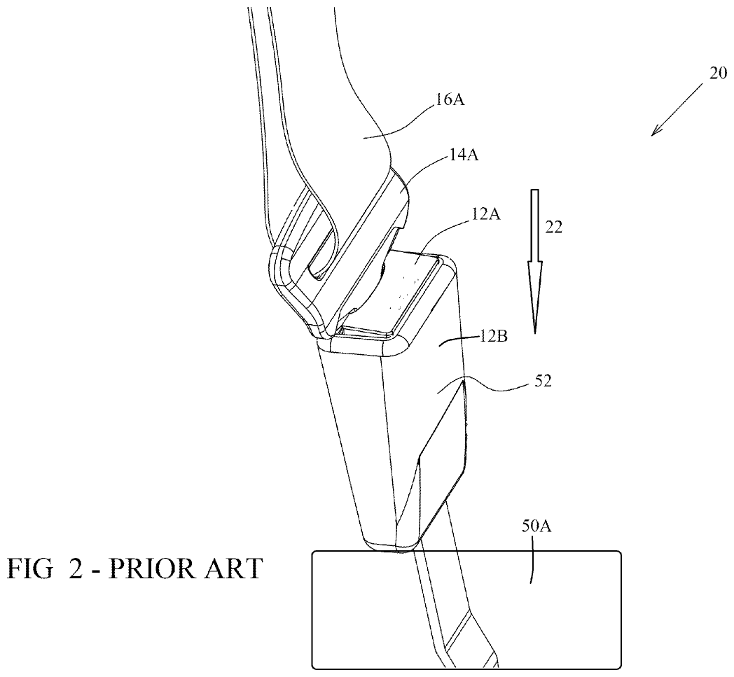

The drawings are not necessarily drawn to scale.

### DETAILED DESCRIPTION

The invention will be understood from the following detailed description of embodiments of the invention, which are meant to be descriptive and not limiting. For the sake of brevity, some well-known features are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

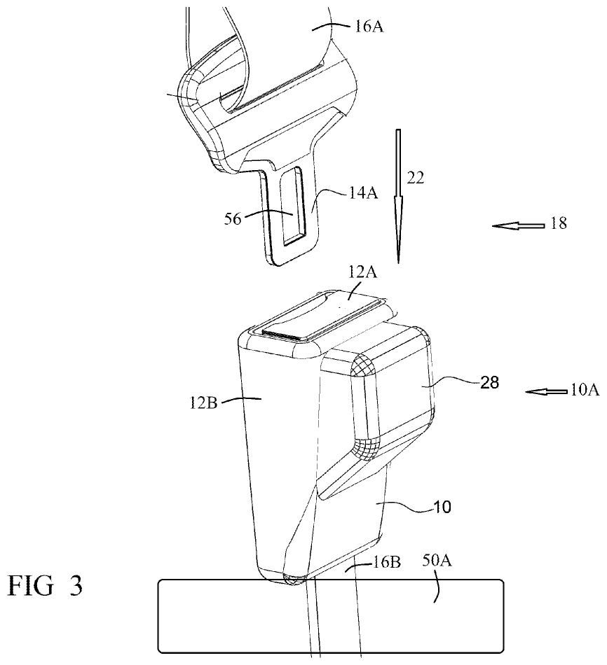

FIG. 3 depicts a seat belt according to one embodiment of the invention, being unlocked.

A seat belt 18 according to one embodiment includes a novel buckle 10A, being secured to seat 50A directly or through a strap 16B, and including an electro-mechanical mechanism 30A (not shown) for improving the function of the buckling.

Seat belt 18 further includes prior art strap 16A, and tongue 14A for being lockable to package 12B including a locking mechanism (not shown) by pressing (22) tongue 14A into package 12B. Mechanism 30A (not shown) is covered by a cover 28.

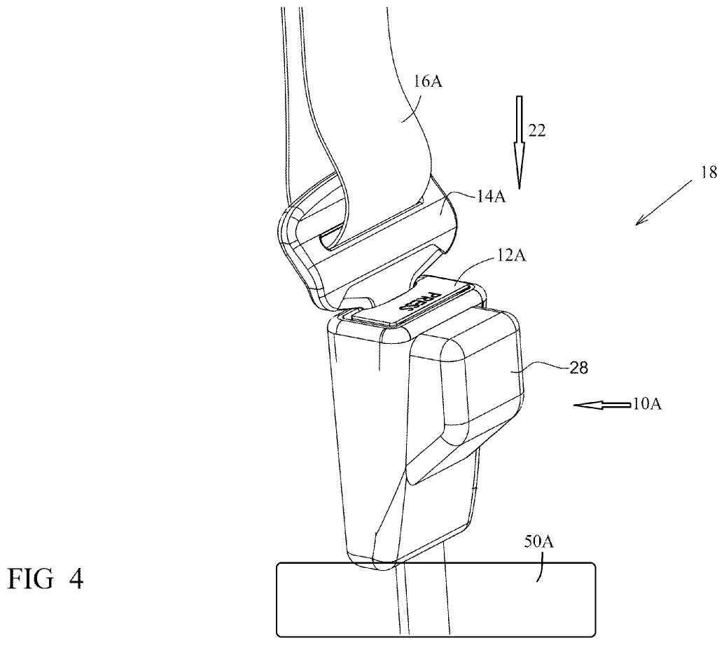

FIG. 4 depicts the seat belt of FIG. 3 being locked.

Tongue 14A is for being lockable to buckle 12.

Buckle 10A includes button 12A, for sliding (22) it in relation to package 12B, for releasing the locking by pressing on button 12A.

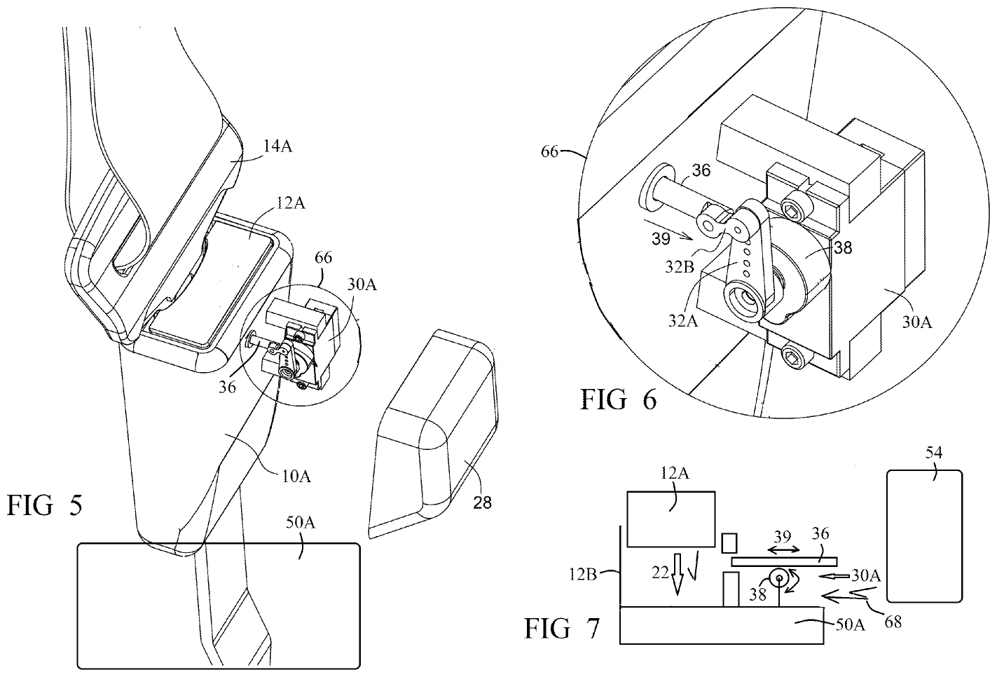

FIG. 5 depicts the seat belt of FIG. 3 being locked and removed of the package, at the state being immediately after the locking of the tongue to the buckle.

FIG. 6 enlarges the mechanism at the state of FIG. 5.

Mechanism 30A includes a latch 36, being slideable (39) by a user interface 54.

FIG. 7 depicts the latch and the button of FIG. 5.

At the state of FIG. 5 and FIG. 6, being immediately after the locking of tongue 14A to buckle 10A, latch 36 does not disturb, thus allows sliding 22 of button 12A by pressing thereon.

A solenoid or motor 38 may slide latch 36.

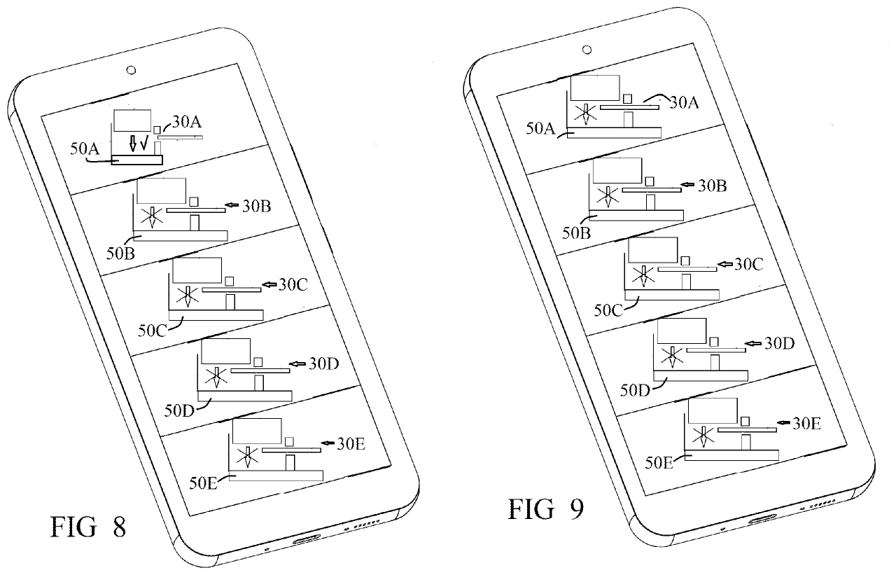

FIG. 8 depicts a user interface, for controlling the mechanism of FIG. 7, at the state of FIG. 7.

A user interface 54, such as smartphone communicating (68) wirelessly to mechanism 30A, or being part of the vehicle's dashboard and communicating wirely to mechanism 30A, controls motor 38 of mechanism 30A of seat 50A, and another motor 38 of mechanism 30B of seat 50B, etc., each independently.

Thus, the driver can allow releasing all the safety buckles, or choose a specific one.

FIG. 8 shows a state that user interface 54 controls mechanism 30A to dispose its latch 36 to allow sliding (22) its button 12A.

FIG. 9 depicts the user interface of FIG. 8 controlling the mechanism of FIG. 7 to a different state.

The user, such as the driver may operate user interface 54 to control mechanisms 30A, 30B to other states.

FIG. 9 shows a case where the user operates user interface 54 to control mechanism 30A to avoid sliding its button 12A, while controlling mechanisms 30B, 30C, etc. to avoid sliding their buttons 12A.

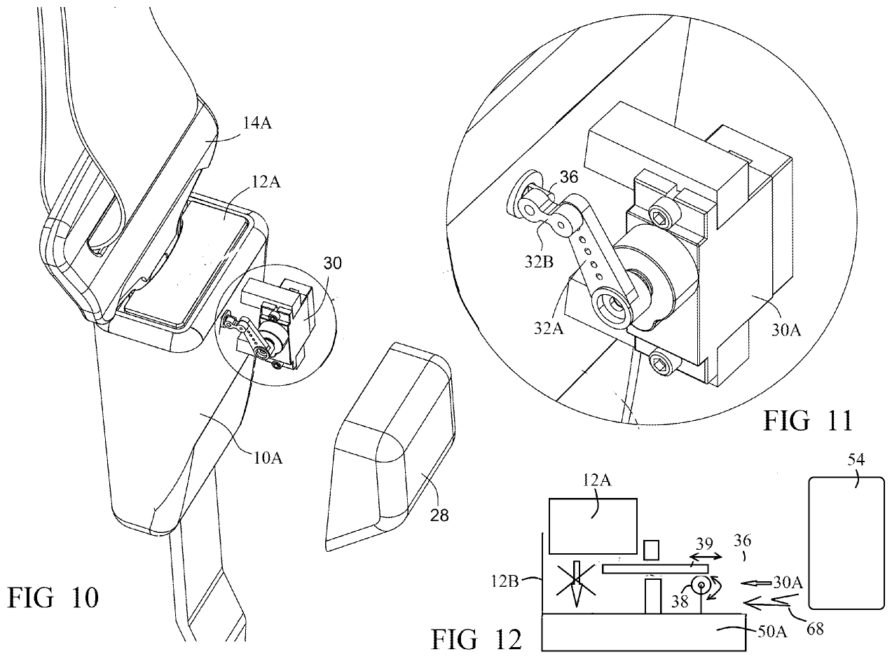

FIG. 10 depicts the seat belt of FIG. 3 being locked and removed of the package, once the user operates the user interface to avoid sliding the button.

FIG. 11 enlarges the mechanism at the state of FIG. 10.

FIG. 12 depicts the latch and the button of FIG. 11.

At the state of FIG. 10, FIG. 11 and FIG. 12, being after the locking of tongue 14A to buckle 10A, and after the driver has operated user interface 54 to avoid opening the seat belt, solenoid or motor 38 slides latch 36 to a position that pressing on button 12A does not slide button 12A, since latch 36 avoids sliding 22 of button 12A. Thus, a passenger lacking user interface 54 cannot open the seat belt.

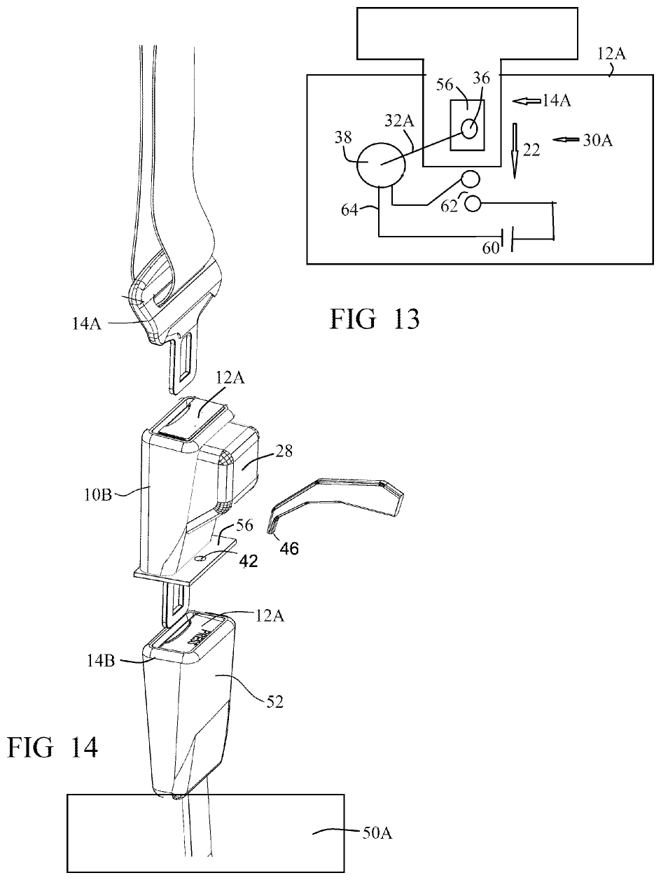

FIG. 13 depicts the mechanism of FIG. 6 according to another embodiment.

Mechanism 30A may disallow releasing tongue 14A from package 12B by inserting latch 36 into hole 56 of tongue 14A.

Mechanism 30A may be configured to automatically disallow releasing of tongue 14A from package 12B upon the insertion/pressing 22 of tongue 14A into package 12B.

The automatic disallowing may be obtained by pressing 22 tongue 14A on a switch 62 to operate motor 38 directly to slide latch 36, or to report insertion 22 to user interface 54, which operates motor 38.

Thus, a plurality of passengers, each upon pressing tongue 14A by himself to lock the seat belt, cannot release tongue 14A by himself. The driver only having user interface 54 can then allow each passenger independently from the other, to release his tongue 14A by himself.

FIG. 14 depicts a seat belt shown unlocked according to another embodiment of the invention.

Seat belt 18 according to another embodiment includes prior art buckle 52, being secured to seat 50A; a novel buckle 10B including mechanism 30A (not shown) covered by cover 28; prior art strap 16A; and prior art tongue 14A.

Buckle 10B further includes a tongue 14B for being locked by buckle 52.

Buckle 10B may include an article 56, such as a plate, for covering button 12A of buckle 52, for not allowing a passenger pressing on button 12A, for not allowing removing buckle 10B from tongue 14B of buckle 10B.

The driver may be accompanied by a special tool 46 that the passengers do not have, for removing buckle 10B from tongue 14B.

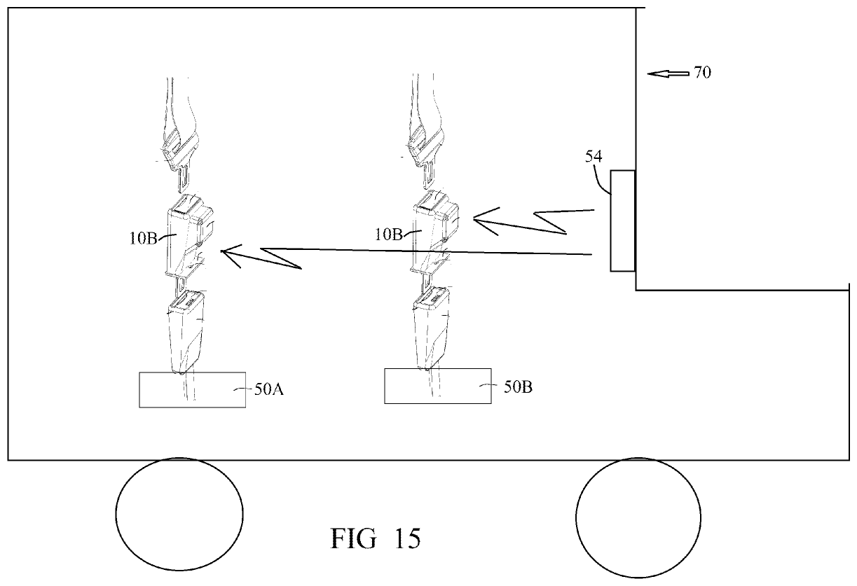

FIG. 15 depicts a vehicle including the buckles of FIG. 14.

A vehicle 70 includes a first buckle 10B for the belt of seat 50A, a second buckle 10B for the belt of seat 50B, and user interface 54 communicating with (68) both buckles for controlling them.

Thus, in one aspect, the invention is directed to a buckle (10A, 10B) for a seat belt (18), the buckle (10A) including an electro-mechanical mechanism (30A) being user operable to allow mechanical opening of the buckle (10A).

The buckle (10A) may further include a user interface (54) for operating the electro-mechanical mechanism (30A).

The invention is further directed to at least two of these buckles (10A), wherein the user interface (54) is for operating each of the electro-mechanical mechanisms (30A) independently.

The buckle (10A) may further include a package (12B) and a pressable button (12A) being slideable in relation to the package (12B) for releasing a first tongue (14A) from the package (12B), wherein the electro-mechanical mechanism (30A) includes a latch (36) being slideable to allow and to disallow the slidability of the pressable button (12A) in relation to the package (12B).

The electro-mechanical mechanism (30A) may include a latch (36), being slideable to insert into a hole (56) of the tongue (14A) for disallowing removal of the tongue (14A) from the buckle (10A), and being slideable to exit the hole (56) for allowing the removal of the first tongue (14A) from the buckle (10A).

The electro-mechanical mechanism (30A) may be automatically operable to disallow mechanical opening of the buckle (10A).

The buckle (10A) may be secured to a seat (50A).

The buckle (10A) may further include a second tongue (14B), for being locked to another buckle (52) being secured to a seat (50A).

The buckle (10A) may further include an article (56) for avoiding access to the button (12A) of the other buckle (52), the button configured to release any tongue from the other buckle (52).

In the figures and description herein, the following reference numbers (Reference Signs List) have been mentioned:
numbers 10A, 10B denote the buckles according to the invention;
12A: button;
12B: package housing a locking mechanism;
14A, 14B: tongues being lockable;
16A, 16B: straps;
18: seat belt according to the invention;
20: prior art seat belt;
22: sliding by pressing to insert tongue 14A;
28: cover;
30A: electro-mechanical mechanism of buckle 10A of seat 50A;
30B: electro-mechanical mechanism of seat 50B;
30C, 30D, 30E: electro-mechanical mechanism of seats 50C, 50D, 50E respectively;
32A, 32B: motion convertors;
36: latch;
38: solenoid or motor;
39: sliding;
42: access for tool 46 to button 12A;
46: special tool;
50A, 50B, 50C, 50D, 50E: seats, each having a belt 18;
52: prior art buckle;
54: user interface;
56: hole;
60: battery;
62: switch or micro-switch;
64: electric wire;
66: zone;
68: communication;
70: vehicle.

The foregoing description and illustrations of the embodiments of the invention have been presented for the purpose of illustration, and are not intended to be exhaustive or to limit the invention to the above description in any form.

Any term that has been defined above and used in the claims, should be interpreted according to this definition.

The reference numbers in the claims are not a part of the claims, but rather used for facilitating the reading thereof. These reference numbers should not be interpreted as limiting the claims in any form.

What is claimed is:

1. A buckle for a seat belt, said buckle comprising:
an electro-mechanical mechanism being user operable to allow mechanical opening of said buckle.

2. The buckle according to claim 1, further comprising:
a user interface for operating said electro-mechanical mechanism.

3. At least two buckles according to claim 2, wherein said user interface is for operating each of said electro-mechanical mechanisms independently.

4. The buckle according to claim 1, further comprising:
a package; and
a pressable button being slideable in relation to said package for releasing a first tongue from said package,
wherein said electro-mechanical mechanism comprises a latch being slideable to allow and to disallow said slidability of said pressable button in relation to said package.

5. The buckle according to claim 1,
wherein said electro-mechanical mechanism comprises a latch,
being slideable to insert into a hole of a first tongue for disallowing removal of said first tongue from said buckle, and
being slideable to exit said hole for allowing said removal of said first tongue from said buckle.

6. The buckle according to claim 1, wherein said electro-mechanical mechanism is automatically operable to disallow mechanical opening of said buckle.

7. The buckle according to claim 1, being secured to a seat.

8. The buckle according to claim 1, further comprising:
a second tongue, for being locked to another buckle being secured to a seat.

9. The buckle according to claim 8, further comprising:
an article for avoiding access to a button of said other buckle, the button configured to release any tongue from said other buckle.
